(19) United States
(12) Patent Application Publication
(10) Pub. No.: US 2008/0155158 A1
(43) Pub. Date: Jun. 26, 2008

(54) PCI INTERFACE CARD

(75) Inventors: HENG YU, Shenzhen (CN); FENG-LONG HE, Shenzhen (CN)

Correspondence Address: PCE INDUSTRY, INC.;ATT. CHENG-JU CHIANG, 458 E. LAMBERT ROAD, FULLERTON, CA, 92835, US

(73) Assignees: HONG FU JIN PRECISION INDUSTRY (Shen Zhen) Co., LTD, Shenzhen City (CN); HON HAI PRECISION INDUSTRY CO., LTD., Tu-Cheng (TW)

(21) Appl. No.: 11/862,199

(22) Filed: Sep. 27, 2007

(30) Foreign Application Priority Data
Dec. 22, 2006 (CN) 200610201374.5

(51) Int. Cl. G06F 13/00

(52) U.S. Cl. 710/301; 710/313

(57) ABSTRACT

An exemplary PCI interface card includes a printed circuit board having a plurality of testing points arranged thereon, and a connecting portion configured to engage in a PCI connector of a motherboard. The connecting portion protrudes from the printed circuit board, and has a plurality of golden fingers disposed thereon. Some of the golden fingers configured to respectively connect with contacts of the PCI connector, which are set to connect with a south bridge chip of the motherboard to transmit address and data signals, are respectively electronically connected to the testing points of the printed circuit board.

### BACKGROUND

1. Field of the Invention

The present invention relates to interface cards, and particularly to a card using the peripheral component interconnect (PCI) interface.

2. Description of Related Art

PCI is a computer bus used for attaching peripheral devices to a computer motherboard. It is the most popular local I/O bus used today. PCI supports both 32-bit and 64-bit data paths and can run at clock speeds of 33 MHz or 66 MHz.

A PCI connector is mounted on a motherboard and electrically connected to a south bridge chipset through a PCI bus for transferring data and information. The south bridge chipset is mounted on the motherboard during a solder reflow process, if there exists an open solder joint between the south bridge chipset and the motherboard, data transfer between the south bridge chipset and the PCI connector cannot be accomplished. So a conventional method for detecting pin-open faults between the south bridge chipset and the motherboard is testing address and data (AD) signals at the PCI connector. However, it is difficult to test the AD signals because the PCI connector has many AD signal pins and the solder joints of the PCI connector is on the rear surface of the motherboard.

What is needed, therefore, is a card using the PCI interface to overcome the above-described deficiencies.

### SUMMARY

An exemplary PCI interface card includes a printed circuit board having a plurality of testing points arranged thereon, and a connecting portion configured to engage in a PCI connector of a motherboard. The connecting portion protrudes from the printed circuit board, and has a plurality of golden fingers disposed thereon. Some of the golden fingers configured to respectively connect with contacts of the PCI connector, which are set to connect with a south bridge chip of the motherboard to transmit address and data signals, are respectively electronically connected to the testing points of the printed circuit board.

Other advantages and novel features will become more apparent from the following detailed description when taken in conjunction with the accompanying drawings, in which:

### BRIEF DESCRIPTION OF THE DRAWINGS

FIG. 1 is a schematic diagram of a PCI interface card in accordance with an embodiment of the present invention, together with a multi-meter; and

FIG. 2 is a circuit diagram of the PCI interface card of FIG. 1.

### DETAILED DESCRIPTION

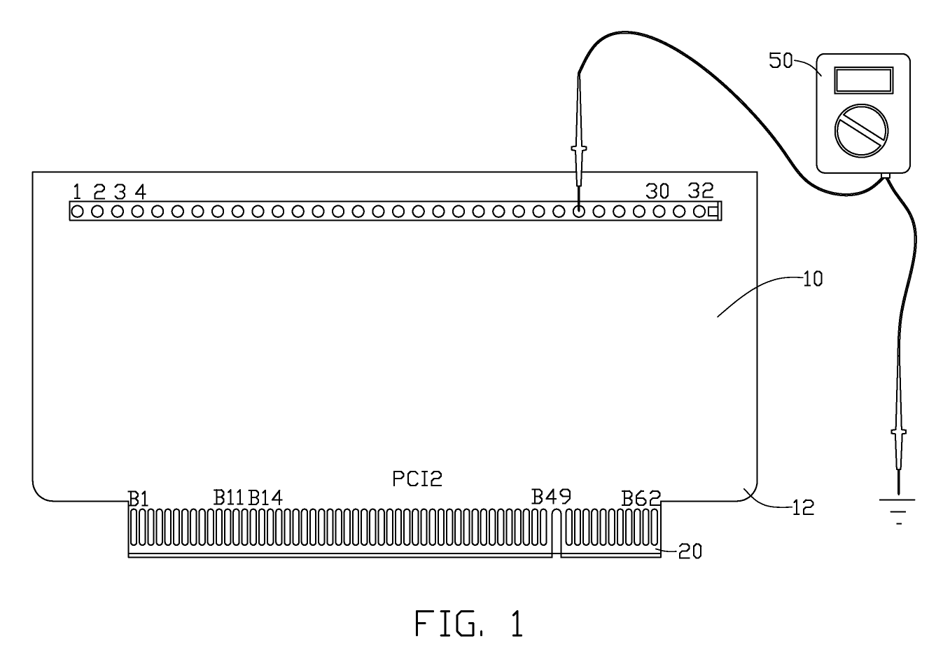

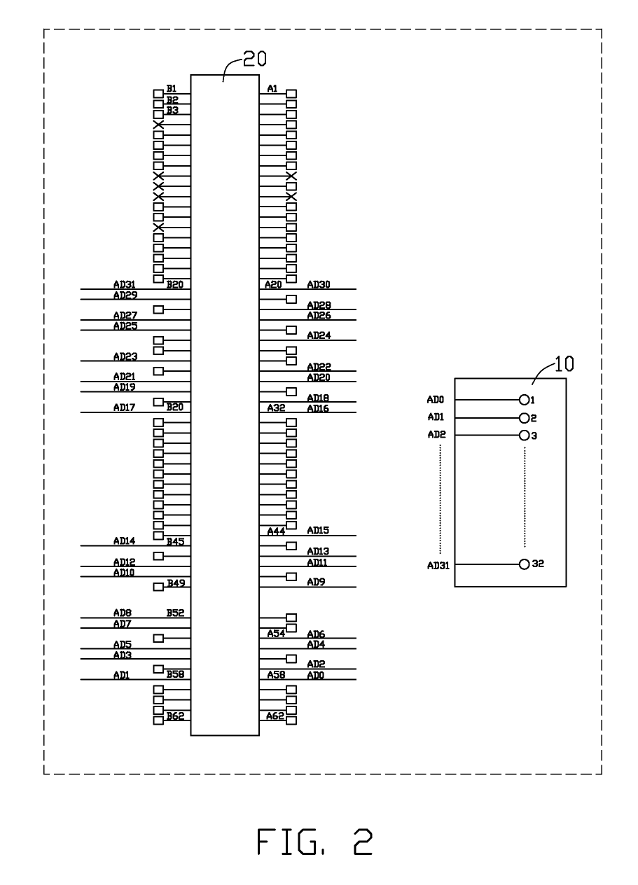

Referring to FIGS. 1 and 2, a PCI interface card in accordance with an embodiment of the present invention includes a printed circuit board 10 and a connecting portion 20 protruding from the printed circuit board 10. The connection portion 20 can engage in a PCI connector of a motherboard, and has a number of golden fingers. The printed circuit board 10 has two protruding shoulders 12 at opposite sides thereof respectively, adjoining the connection portion 20 for facilitating plugging in or pulling out the PCI interface card of the PCI connector of the motherboard, and protecting the connection portion 20. In this embodiment, the number of the golden fingers is 124, in other embodiments the number of the golden finger can be different. The golden fingers are arranged in two rows along opposite long sidewalls of the connection portion 20 respectively, a first row includes golden fingers A1˜A62, a second row includes golden fingers B1˜B62, a function of each golden finger A1˜A62, B1˜B62 is defined according to the PCI standard, the definition of each golden finger can be found in table 1. According to the table 1, there are 32 golden fingers A58, B58, A57, B56, A55, B55, A54, B53, B52, A49, B48, A47, B47, A46, B45, A44, A32, B32, A31, B30, A29, B29, A28, B27, A25, B24, A23, B23, A22, B21, A20, and B20 used for transmitting AD signals AD0˜AD31. The printed circuit board 10 has 32 testing points 1˜32 arranged in a row on the printed circuit board 10 and respectively coupled to the golden fingers which are used to transmit AD signals via transmission lines etched in the printed circuit board 10. In FIG. 2, the connections between the golden fingers and the testing points are shown.

Use of the PCI interface card to test the north bridge is as follows. The PCI interface card is plugged into the PCI connector of the motherboard, and the golden fingers establish an effective connection between the PCI interface card and the PCI connector of the motherboard. A multi-meter 50 is set to a resistance (in ohms) function and has two meter probes, one of the meter probes is grounded, and the other meter probe touches the testing points 1˜32 one by one, readings are obtained on a display of the multi-meter. The readings are compared to reference values, if the readings are the same as the reference values, the connection between the south bridge chipset and the motherboard is good, if there is a reading on the multi-meter 50 different from the corresponding reference value, an open solder joint exists between the south bridge chipset and the motherboard.

Labels 1-32 are marked on the printed circuit board 10 adjacent to corresponding testing points, thereby, it can easily be known which solder joint of the PCI connector on the motherboard is an open solder joint.

The PCI interface card can also be used to test the south bridge. The PCI interface card is plugged into the PCI connector of the motherboard, a logic analyzer is used to capture the signals on the testing points 1˜32, and the signals are analyzed by the user one by one to determine whether the south bridge chipset works normally.

The PCI interface card has testing points electronically connected to the golden fingers, under testing, the PCI interface card is plugged into the PCI connector of the motherboard, and performance of the south bridge chipset can be easily obtained by testing signals on the testing points of the PCI interface card.

The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

TABLE 1

| golden finger | Signal |
|---|---|
| A1 | #TRST |
| A2 | +12 V |
| A3 | TMS |
| A4 | TDI |
| A5 | +5 V |
| A6 | #INTA |
| A7 | #INTC |
| A8 | +5 V |
| A9 | NA |
| A10 | +V I/O |
| A11 | NA |
| A12 | GND |
| A13 | GND |
| A14 | NA |
| A15 | #RST |
| A16 | +V I/O |
| A17 | #GNT |
| A18 | GND |
| A19 | NA |
| A20 | AD30 |
| A21 | +3.3 V |
| A22 | AD28 |
| A23 | AD26 |
| A24 | GND |
| A25 | AD24 |
| A26 | IDSEL |
| A27 | +3.3 V |
| A28 | AD22 |
| A29 | AD20 |
| A30 | GND |
| A31 | AD18 |
| A32 | AD16 |
| A33 | +3.3 V |
| A34 | #FRAME |
| A35 | GND |
| A36 | #TRDY |
| A37 | GND |
| A38 | #STOP |
| A39 | +3.3 V |
| A40 | SDONE |
| A41 | #SBO |
| A42 | GND |
| A43 | PAR |
| A44 | AD15 |
| A45 | +3.3 V |
| A46 | AD13 |
| A47 | AD11 |
| A48 | GND |
| A49 | AD9 |
| A50 | KEY |
| A51 | KEY |
| A52 | C/#BE0 |
| A53 | +3.3 V |
| A54 | AD6 |
| A55 | AD4 |
| A56 | GND |
| A57 | AD2 |
| A58 | AD0 |
| A59 | +V I/O |
| A60 | #REQ64 |
| A61 | +5 V |
| A62 | +5 V KEY |
| B1 | −12 V |
| B2 | TCK |
| B3 | GND |
| B4 | TDO |
| B5 | +5 V |
| B6 | +5 V |
| B7 | #INTB |
| B8 | #INTD |
| B9 | #PRSNT1 |
| B10 | NA |
| B11 | #PRSNT2 |
| B12 | GND |
| B13 | GND |
| B14 | NA |
| B15 | GND |
| B16 | CLK |
| B17 | GND |
| B18 | #REQ |
| B19 | +V I/O |
| B20 | AD31 |
| B21 | AD29 |
| B22 | GND |
| B23 | AD27 |
| B24 | AD25 |
| B25 | +3.3 V |
| B26 | C/#BE3 |
| B27 | AD23 |
| B28 | GND |
| B29 | AD21 |
| B30 | AD19 |
| B31 | +3.3 V |
| B32 | AD17 |
| B33 | C/#BE2 |
| B34 | GND |
| B35 | #IRDY |
| B36 | +3.3 V |
| B37 | #DEVSEL |
| B38 | GND |
| B39 | #LOCK |
| B40 | #PERR |
| B41 | +3.3 V |
| B42 | #SERR |
| B43 | +3.3 V |
| B44 | C/#BE1 |
| B45 | AD14 |
| B46 | GND |
| B47 | AD12 |
| B48 | AD10 |
| B49 | GND |
| B50 | KEY |
| B51 | KEY |
| B52 | AD8 |
| B53 | AD7 |
| B54 | +3.3 V |
| B55 | AD5 |
| B56 | AD3 |
| B57 | GND |
| B58 | AD1 |
| B59 | +V I/O |
| B60 | #ACK64 |
| B61 | +5 V |
| B62 | +5 V KEY |

What is claimed is:

1. A peripheral component interconnect (PCI) interface card comprising:
a printed circuit board having a plurality of testing points arranged thereon;
a connecting portion configured to engage in a PCI connector of a motherboard, the connecting portion protruding from the printed circuit board, and having a plurality of golden fingers disposed thereon, wherein some of the plurality of golden fingers, configured to respectively connect with contacts of the PCI connector which are set to connect with a south bridge chip of the motherboard to transmit address and data signals, are electronically connected to the testing points of the printed circuit board respectively.

2. The PCI interface card as claimed in claim 1, wherein the printed circuit board has two protruding shoulders at opposite sides thereof respectively.

3. The PCI interface card as claimed in claim 1, wherein the golden fingers are arranged in two rows on a same face along opposite long sidewalls of the connecting portion, each row has the same number of golden fingers.

4. The PCI interface card as claimed in claim 1, wherein the testing points are arranged in a row on the printed circuit board.

5. The PCI interface card as claimed in claim 1, wherein a function of each golden finger is defined according to the PCI standard.

6. A peripheral component interconnect (PCI) interface card configured for engaging in a PCI connector of a motherboard, comprising:
a printed circuit board having a plurality of testing points arranged thereon,
a connecting portion protruding from the printed circuit board; and
a plurality of golden fingers disposed on the connection portion, wherein a definition of each of the plurality of golden fingers is within a limitation of a PCI specification, the golden fingers used for transmitting address signals and data signals according to the PCI specification are respectively connected to the testing points of the printed circuit board.

7. A test apparatus comprising:
a peripheral component interconnect (PCI) interface card comprising a printed circuit board having a plurality of testing points arranged thereon, and a connecting portion extending from the printed circuit board and configured to engage in a PCI connector of a motherboard, the connecting portion having a plurality of golden fingers, configured to respectively connect with contacts of the PCI connector which are set to connect with a south bridge chip of the motherboard to transmit address and data signals, said golden fingers connecting with the testing points separately; and
a multi-meter having two probes with one of which selectively touching one of the testing points to indicate whether connections of the contacts of the PCI connector and the south bridge chip are good.
